(19) United States
(12) Patent Application Publication
(10) Pub. No.: US 2005/0169473 A1
(43) Pub. Date: Aug. 4, 2005

(54) Multiple selective encryption with DRM

(76) Inventor: Brant L. Candelore, Escondido, CA (US)

Correspondence Address: MILLER PATENT SERVICES, 2500 DOCKERY LANE, RALEIGH, NC, 27606, US

(21) Appl. No.: 10/964,267

(22) Filed: Oct. 13, 2004

Related U.S. Application Data
(60) Provisional application No. 60/541,339, filed on Feb. 3, 2004.

(51) Int. Cl. H04N 7/167

(52) U.S. Cl. 380/239

(57) ABSTRACT

A method of encrypting a digital television signal consistent with certain embodiments involves examining unencrypted packets of data in the digital television signal to identify a packet type; duplicating packets identified as being of the packet type to create first and second duplicate packets; encrypting the first duplicate packets according to a conditional access encryption method to create conditional access encrypted packets; encrypting the second duplicate packets according to a Digital Rights Management (DRM) encryption method to create DRM encrypted packets; and replacing the unencrypted packets of the packet type with the conditional access encrypted packets and the DRM encrypted packets in the digital television signal to produce a multiple partially encrypted digital television signal. This abstract is not to be considered limiting, since other embodiments may deviate from the features described in this abstract.

### CROSS REFERENCE TO RELATED DOCUMENTS

This application claims priority benefit of U.S. provisional patent application Ser. No. 60/541,339 filed Feb. 3, 2004, which is hereby incorporated by reference. This application is also related to published U.S. patent application Ser. No. 10/038,217; Ser. No. 10/038,032; Ser. No. 10/037,914; Ser. No. 10/037,499; and Ser. No. 10/037,498 all of which were filed on Jan. 2, 2002 and are hereby incorporated by reference herein.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

A conventional cable system arrangement is depicted in FIG. 1. In such a system, the cable operator processes audio/video (A/V) content 14 with CA technology from manufacturer A (system A) using CA encryption equipment 18 compliant with system A at the cable system headend 22. The encrypted A/V content along with system information (SI) 26 and program specific information (PSI) 27 is multiplexed together and transmitted over the cable system 32 to a user's STB 36. STB 36 incorporates decrypting CA equipment from system A (manufacturer A) 40 that decrypts the A/V content. The decrypted A/V content can then be supplied to a television set 44 for viewing by the user.

In a cable system such as that of FIG. 1, digital program streams are broken into packets for transmission. Packets for each component of a program (video, audio, auxiliary data, etc.) are tagged with a packet identifier or PID. These packet streams for each component of all programs carried within a channel are aggregated into one composite stream. Additional packets are also included to provide decryption keys and other overhead information. Otherwise unused bandwidth is filled with null packets. Bandwidth budgets are usually adjusted to utilize about 95% of the available channel bandwidth.

Overhead information usually includes guide data describing what programs are available and how to locate the associated channels and components. This guide data is also known as system information or SI. SI may be delivered to the STB in-band (part of the data encoded within a channel) or out-of-band (using a special channel dedicated to the purpose). Electronically delivered SI may be partially duplicated in more traditional forms—grids published in newspapers and magazines.

Digital Rights Management (DRM) is becoming an increasingly important mechanism for protection of copyrighted content that is distributed for use by consumers. As an example, DRM can be used within the context of a digital television receiver device (e.g., a set top box or television receiver) so that a movie that is received from a cable operator can be recorded in digital form and played back a set number of times over a period of time. In another example, DRM could be used to specify that playback can only occur on a particular device (e.g., a set top box having a disc drive—i.e., a Personal Video Recorder or PVR).

### BRIEF DESCRIPTION OF THE DRAWINGS

Certain illustrative embodiments illustrating organization and method of operation, together with objects and advantages may be best understood by reference detailed description that follows taken in conjunction with the accompanying drawings in which:

FIG. 1 is a block diagram of a conventional conditional access cable system.

FIG. 2 is a block diagram of an embodiment of a cable system consistent with certain embodiments of the present invention.

FIG. 3 is another block diagram of a cable system consistent with certain embodiments of the present invention.

FIG. 4 is a flow chart depicting an exemplary encoding consistent with certain embodiments of the present invention.

FIG. 5 is a flow chart depicting a decryption and PID remapping process consistent with certain embodiments of the present invention.

FIG. 6 is a block diagram illustrating a gateway STB providing multiple selective encryption services consistent with certain embodiments of the present invention.

FIG. 7 is a flow chart depicting operation of a gateway STB and associated appliances on a home network consistent with certain embodiments of the present invention.

FIG. 8 is a block diagram of an exemplary gateway STB consistent with certain embodiments of the present invention.

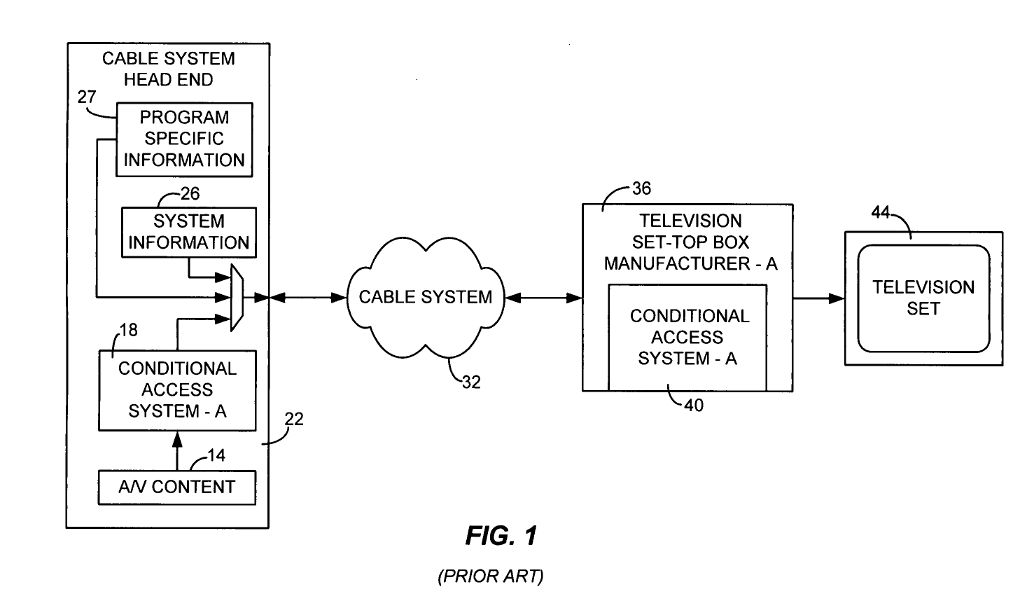

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically. The term “program”, as used herein, is defined as a sequence of instructions designed for execution on a computer system. A “program”, or “computer program”, may include a subroutine, a function, a procedure, an object method, an object implementation, in an executable application, an applet, a servlet, a source code, an object code, a shared library/dynamic load library and/or other sequence of instructions designed for execution on a computer system.

The terms “scramble” and “encrypt” and variations thereof are used synonymously herein. The term “video” may be used herein to embrace not only true visual information, but also in the conversational sense (e.g., “video tape recorder”) to embrace not only video signals but also associated audio and data. The present document generally uses the example of a “dual selective encryption” embodiment, but those skilled in the art will recognize that the present invention can be utilized to realize multiple partial encryption without departing from the invention. The terms “partial encryption” and “selective encryption” are used synonymously herein. Also, the terms “program” and “television program” and similar terms can be interpreted in the normal conversational sense, as well as a meaning wherein the term means any segment of A/V content that can be displayed on a television set or similar monitor device.

The term “legacy” as used herein refers to existing technology used for existing cable and satellite systems. The exemplary embodiments disclosed herein are decoded by a television Set-Top Box (STB), but it is contemplated that such technology will soon be incorporated within television receivers of all types whether housed in a separate enclosure alone or in conjunction with recording and/or playback equipment or Conditional Access (CA) decryption module or within a television set itself.

The present document generally uses the example of a “dual partial encryption” embodiment, but those skilled in the art will recognize that the present invention can be utilized to realize multiple partial encryption without departing from the invention.

For purposes of this document, a distinction is drawn between Conditional Access (CA) and Digital Rights Management (DRM). Broadly speaking, legacy CA can be considered a form of DRM, since it provides a measure of management of the digital rights of the owner by preventing unauthorized viewing using encryption. Similarly, DRM can be considered a type of conditional access. Thus, a dividing line should be drawn.

In legacy CA, Entitlement Control Messages and/or Entitlement Management Messages (with or without an a smart card or CableCard™, are used to permit or prohibit a recipient of encrypted content to view content. Thus, a legacy CA system (or simply a CA system herein for short) can be considered to be a more simple form of DRM, associated with the simple purchase and real-time access to programming. With legacy CA, the recording of standard definition analog output to VCR is allowed as “fair use” of normal programming. For premium content, the recording is controlled by copy control technology such as that provided by Macrovision.

Until recently, television set-top boxes did not have the ability to store or output content in its digital form, and the home networking was non-existent. The “home network” involved the home user manually moving a recorded VHS tape from one VCR to another. Consequently, legacy CA, mainly dealt with the processing of keys to decrypt the content in real-time. The term DRM, in contrast, is a used to denote a more sophisticated form of protection in which additional restrictions can be imposed upon the use of content over and above that provided in a legacy CA system.

The authorization and key management methods used in DRM are incompatible with legacy CA, and unless standardized, are generally incompatible with each other. With the advent of Digital Video Recorders (DVRs), also known as Personal Video Recorders (PVRs), digital content can now be stored in the set-top box in its transmitted resolution along with meta-data controlling its use. The content may be stored on an internal or extenal hard drive or recorded to DVD. Content distributors are being required by content providers to secure digital content. Using legacy CA, the hard drive and DVD may be cryptographically tethered to a particular set-top box by encrypting content to that storage medium and decrypting content when receiving it back from that medium. Content recorded by the set-top box may be un-playable in other set-top boxes and may have no expiration except that on a hard drive, the capacity of the drive is eventually used up and the viewer needs to erase content in order to make room for new content. Using DRM, however, the recorded content can be now be shared with other devices and appliances and may have more extensive usage rules. DRM is aware of these more extensive usage rules and the various appliances and networks on which customers want to share content.

The playback of the content can be subject to extensive usage rules. For example, in a DRM system, rights can be established on the basis of time, target device, number of plays or other restraints. Such rights are determined, in current DRM systems, by virtue of a set of DRM meta-data that accompanies the content. This meta-data can be hashed in such a way to generate a key or data input to key decryption operations. Hashing the meta-data and generating key or data input values in this way is a way to authenticate the meta-data in order to prevent manipulation by a hacker. Such DRM meta-data contains usage rules that are used to control authorized use to set-top boxes and devices attached to the set-top boxes on the home network, and prevent unauthorized use of the content in a manner beyond that which can be controlled using legacy CA encryption/decryption mechanism which generally only allowed for immediate use and “fair use” recording of analog outputs.

Legacy CA is generally controlled by entitlement message (Entitlement Control Messages and Entitlement Management Messages) to manage keys used in a decryption process. DRM is a metadata driven encryption system capable of more sophisticated restrictions imposed by usage rules forming a part of the metadata. By way of example and not limitation, the following table provides some examples of the capabilities of DRM above and beyond those of legacy CA:

| Feature | Sub-Feature | CA | DRM |
|---|---|---|---|
| Payment | Delivery of Decryption Keys | Yes | Yes |
| Enforcement | Ability to negotiate renewal of | No | Yes |
| | Decryption Keys | | |
| Use | Real-time consumption of broadcast | Yes | Yes |
| Management | content | | |
| | Recorded content playable on the device | Yes | Yes |
| | that recorded the content in the first | (Content is | |
| | place. Content recorded on an embedded | decrypted and reencrypted | |
| | hard drive or drive that is | using a | |
| | cryptographically tethered to the set-top | local key known | |
| | box. | only to set-top | |
| | | box) | |
| | Recorded content playable on other | No | Yes |
| | related devices, e.g. other set-top boxes | | |
| | from the same manufacturer (and | | |
| | possibly same owner) | | |
| | Recorded content playable on various | No | Yes |
| | portable appliances | | |
| | Pay-per-play use model | No | Yes |
| | Pay-per-time use model | No | Yes |
| Copy | Copy control over Analog Output (e.g. | Yes | Yes |
| Control | Macrovision) | | |
| | Delivery of Copy control information | Yes | Yes |
| | such as copy free, copy once, copy no | (CA application | (DRM maintains |
| | more, copy never are output from the | passes the | control over the |
| | security function to the set-top box | information over | copy states) |
| | allowing very basic control of content | to other set-top | |
| | | box application) | |
| | Copy control information allowing | No | Yes |
| | multiple copies | | (DRM maintain |
| | | | control over the |
| | | | copy states) |
| | Selectable output control over various | No | Yes |
| | digital interfaces | | |

Thus, for purposes of this document, DRM can be considered to be any encryption system that exceeds the general capabilities of a legacy CA system in any way. However, it is noted that due to the proprietary nature of most CA and DRM systems, the above table and discussion should be considered to be general guidance and not strictly limiting.

With the advent of home networks, digital content can be shared between devices. Set-top boxes are being built with Ethernet and IEEE1394 connections allowing compressed digital content to be shared amongst authorized devices, e.g. TVs, Personal Digital Assistants (PDAs), and digital-VCRs. A problem exists in that that currently, all devices must have a common DRM scheme to receive content. Control of the DRM technology is deemed of strategic importance to many companies and there is great reluctance to include this technology in expensive, generic appliances such as TVs and digital-VCRs.

A technique referred to as “selective encryption” or “partial encryption” is described in Published U.S. patent application Ser. No. 10/038,217; Ser. No. 10/038,032; Ser. No. 10/037,914; Ser. No. 10/037,499; and Ser. No. 10/037,498 all of which were filed on Jan. 2, 2002 and are hereby incorporated by reference herein.

The above-referenced patent applications describe inventions relating to various aspects of methods generally referred to herein as partial encryption or selective encryption. More particularly, systems are described therein where selected portions of a particular selection of digital content are encrypted using two (or more) encryption techniques while other portions of the content are left unencrypted. By properly selecting the portions to be encrypted, the content can effectively be encrypted for use under multiple decryption systems without the necessity of encryption of the entire selection of content. In some embodiments, only a few percent of data overhead is needed to effectively encrypt the content using multiple encryption systems. This results in a cable or satellite system being able to utilize set-top boxes or other implementations of conditional access (CA) receivers from multiple manufacturers in a single system—thus freeing the cable or satellite company to competitively shop for providers of set-top boxes.

Under certain embodiments consistent with the present invention, one or more of the encryption systems used in a multiple selective encryption system can be associated with a DRM scheme.

In other embodiments consistent with the present invention, content may be received 100% encrypted from the service provider. The encrypted content is decrypted, and then multiple selectively DRM encrypted by the gateway set-top box for various appliances in the home network. The devices in the home network can select from two or more DRM technologies. Content may be decoded real-time or stored multiple encrypted. Encoding issues aside, music content, for example, could be Apple DRM as well as Microsoft (MS) Media Player DRM encrypted. This content would be playable on Apple IPODs (supporting Apple DRM) as well as portable devices supporting MS Media Player.

In other embodiments, the content may be both CA and DRM multiple encrypted. The gateway may pass both forms of encryption into the home network. Alternatively, it may select either only the DRM encryption or only the CA encryption (if there are no DRM enabled devices) along with the clear packets to send into the home network.

DRM encryption can take the home network into account by enabling appliances in the home to share content directly from the headend or service provider. Alternatively, the DRM encryption can be modified by the gateway set-top box in order to customize the content after purchase for its particular home network. Alternatively, the DRM encryption can be synthesized by the gateway set-top box on selected control digital outputs, e.g. Digital Transmission Copy Protection (DTCP) on IEEE1394 or Microsoft Media Player DRM.

Many digital cable networks utilize CA systems that fully encrypt digital audio and video to make programming inaccessible except to those who have properly subscribed. Such encryption is designed to thwart hackers and non-subscribers from receiving programming that has not been paid for. However, as cable operators wish to provide their subscribers with set-top boxes from any of several manufacturers, they are frustrated by the need to transmit multiple copies of a single program encrypted with multiple encryption technologies compliant with the CA systems of each STB manufacturer. This problem is even further exacerbated as cable operators wish to implement further content control using DRM arrangements.

The above-referenced patent applications describe systems wherein selected portions of a particular selection of digital content are encrypted using two (or more) encryption techniques while other portions of the content are left unencrypted. The encrypted portions are identified and distinguished from one another in certain embodiments by use of multiple packet identifiers. By properly selecting the portions to be encrypted, the content can effectively be encrypted for use under multiple decryption systems without the necessity of encryption of the entire selection of content. In some embodiments, only a few percent of data overhead is needed to effectively encrypt the content using multiple encryption systems. This results in a cable or satellite system being able to utilize Set-top boxes or other implementations of conditional access (CA) receivers from multiple manufacturers in a single system thus freeing the cable or satellite company to competitively shop for providers of Set-top boxes. This concept can be further extended to encompass DRM encryption (encryption that is associated with a DRM scheme to provide additional content control). In accordance with embodiments consistent with the present invention, one or more of these encryption systems used for multiple selective encryption can be a DRM system.

The encryption techniques used as taught in the above-referenced patent applications are selectively applied to the data stream, rather than encrypting the entire data stream, using techniques described in the above-referenced patent applications. This technique is also applicable to DRM encryption. In general, but without the intent to be limiting, the selective encryption process utilizes intelligent selection of information to encrypt so that the entire program does not have to undergo dual encryption. By appropriate selection of data to encrypt, the program material can be effectively scrambled and hidden from those who desire to hack into the system and illegally recover commercial content without paying. MPEG (or similar format) data that are used to represent the audio and video data does so using a high degree of reliance on the redundancy of information from frame to frame. Certain data can be transmitted as “anchor” data representing chrominance and luminance data. That data is then often simply moved about the screen to generate subsequent frames by sending motion vectors that describe the movement of the block. Changes in the chrominance and luminance data are also encoded as changes rather than a recoding of absolute anchor data. Thus, encryption of this anchor data, for example, or other key data can effectively render the video un-viewable.

In accordance with certain embodiments consistent with the above inventions, the selected video data to be encrypted may be any individual one or combination of the following (described in greater detail in the above applications): video slice headers appearing in an active region of a video frame, data representing an active region of a video frame, data in a star pattern within the video frame, data representing scene changes, I Frame packets, packets containing motion vectors in a first P frame following an I Frame, packets having an intra_slice_flag indicator set, packets having an intra_slice indicator set, packets containing an intra_coded macroblock, data for a slice containing an intra_coded macroblock, data from a first macroblock following the video slice header, packets containing video slice headers, anchor data, and P Frame data for progressively refreshed video data, data arranged in vertical and or horizontal moat patterns on the video frame, and any other selected data that renders the video and/or audio difficult to utilize. Several such techniques as well as others are disclosed in the above-referenced patent applications, any of which (or other techniques) can be utilized with the present invention to encrypt only a portion of the content.

In order to distinguish between the two or more digital television signals encrypted using the multiple encryption algorithms in accordance with certain embodiments consistent with the above inventions, multiple packet identifiers (PIDs) are utilized. Normally a single set of packet identifiers is used to identify a particular television program. When a television signal is encrypted under the multiple selective encryption arrangement described in the above-referenced applications, the clear content is assigned a first set of PIDs, and each set of encrypted content is assigned another set of PIDs (one set of encrypted content may share the same PID with the unencrypted content in certain embodiments). The receiving STB then remaps all of the appropriate content to a single PID for playback. This process is described in detail in the above patent applications.

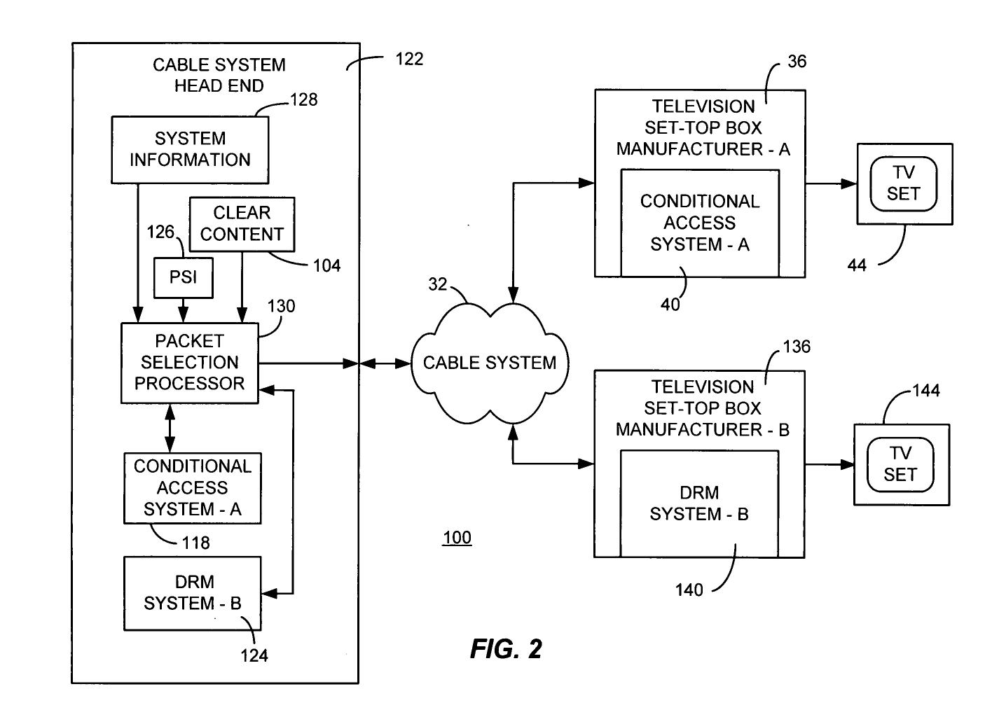

Turning now to FIG. 2, one embodiment of a system that reduces the need for additional bandwidth to provide multiple encryption using DRM as at least one of the encryption techniques is illustrated as system 100. At headend 122, the clear content 104 is provided along with PSI information 126 and System Information (SI) 128 to a packet selection processor 130. Processor 130 selects packets that meet a specified selection criterion for encryption, for example, “critical packets” as described above and explained extensively in the above-referenced patent application. These packets are duplicated and encrypted using both the CA system A and the DRM system B, so that the entire content need not be duplicated and encrypted. The content can then be selectively encrypted at conditional access system A 118. The content can also be selectively encrypted using a DRM system B 124 to produce multiple selectively encrypted content. This multiple selectively encrypted content can then be distributed via the cable system 32 to television set top boxes such as 36 and 136.

Set top box 36 represents a legacy set top box that utilizes conditional access system 40 to decrypt the content for play on television set 44. Set top box 136, one the other hand, is DRM enabled using DRM system 140 to provide decrypted content to television set 144. Following the CA system 40 and DRM system 140 in each STB resides a decoder (not explicitly shown) that decodes the digitally encoded television signal and provides it to television sets 44 and 144 respectively. As with other forms of multiple selective encryption, multiple PIDs can be used to distinctively identify the selected content encrypted under one system or the other.

Both the legacy STB 36 and the new set-top box 136 can function in a normal manner receiving video in the clear and decrypting the audio in the same manner used for fully decrypting encrypted A/V content. If the user has not subscribed to the programming encrypted according to the above scheme, the user will be unable to enjoy the content.

Authorized set-top boxes receive Entitlement Control Messages (ECM) that are used to get access criteria and descrambling keys. The set-top box attempts to apply the keys to the content. Unencrypted content simply passes through the set-top boxes' descrambler unaffected. Packets of content which were selected and scrambled are decrypted either by the conditional access system A or DRM system B. Packets that are encrypted under the DRM system B are then controlled by the usage rights defined in the DRM metadata associated with the selectively encrypted DRM content.

Thus, in this manner, both legacy CA and DRM can coexist in a single cable network. In one variation to this embodiment, The DRM encrypted content can also be encrypted under a conditional access arrangement as well as the DRM scheme.

Thus, in accordance with certain embodiments, a method of encrypting a digital television signal involves examining unencrypted packets of data in the digital television signal to identify a packet type; duplicating packets identified as being of the packet type to create first and second duplicate packets; encrypting the first duplicate packets according to a conditional access encryption method to create conditional access encrypted packets; encrypting the second duplicate packets according to a Digital Rights Management (DRM) encryption method to create DRM encrypted packets; and replacing the unencrypted packets of the packet type with the conditional access encrypted packets and the DRM encrypted packets in the digital television signal to produce a multiple partially encrypted digital television signal.

In certain embodiments, an encrypted television program has a plurality of unencrypted packets; and a plurality of encrypted packets, wherein the encrypted packets include at least a first encrypted packet encrypted under first Digital Rights Management (DRM) encryption method and a second encrypted packet encrypted under a second encryption method.

A television set-top box consistent with certain embodiments has a receiver receiving a digital television, where the signal has a plurality of unencrypted packets; and a plurality of encrypted packets, wherein the encrypted packets comprise at least a first encrypted packet encrypted under first Digital Rights Management (DRM) encryption method and a second encrypted packet encrypted under a second encryption method. A decrypter decrypts either packets encrypted under the first or the second encryption method to produce decrypted packets. A decoder decodes the unencrypted packets and the decrypted packets to produce a signal suitable for play on a television set.

A method of decrypting a multiple partially encrypted television signal consistent with certain embodiments involves receiving a digital television signal comprising a plurality of packets, wherein certain packets of the plurality of packets are encrypted packets, wherein the encrypted packets comprise at least a first encrypted packet encrypted under first encryption method and a second encrypted packet encrypted under a second encryption method, and a remainder of the packets are unencrypted, wherein the first encrypted packets are encrypted under a Digital Rights Management encryption method; and decrypting a packet encrypted under one of the first and second encryption methods to produce decrypted packets.

A method of decrypting a partially encrypted television signal consistent with certain embodiments involves receiving the partially encrypted television signal comprising a plurality of clear packets, a plurality of packets encrypted under a first encryption algorithm, and a plurality of packets encrypted under a second encryption algorithm; wherein the packets encrypted under the first encryption algorithm is encrypted under a Digital Rights Management method; wherein the packets encrypted under the first and second encryption algorithms are packets that are needed to properly decode the television signal; wherein the clear packets are identified by a first packet identifier; wherein the packets encrypted under the first encryption algorithm are identified by a second packet identifier (PID), and wherein the packets encrypted under the second encryption algorithm are identified by a third packet identifier (PID); and decrypting the packets encrypted under the first encryption algorithm to produce decrypted packets.

A computer data signal embodied in a bit stream consistent with certain embodiments, thus, has a segment of data representing an unencrypted packet. Another segment of data represents a first duplicate packet encrypted under a first encryption method, wherein the first encryption method comprises a Digital Rights Management (DRM) encryption method. Another segment of data represents a second duplicate packet encrypted under a second encryption method.

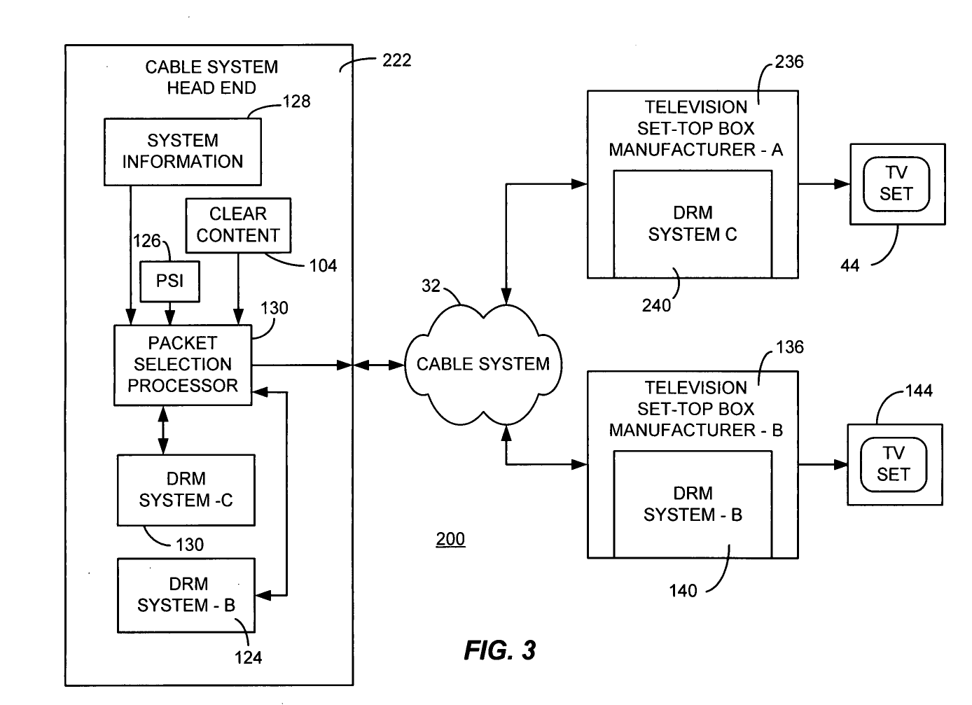

While DRM can be used for one of the encryption systems has illustrated in FIG. 2, FIG. 3 illustrates a system in which DRM can be used for multiple encryption. In this embodiment, two DRM systems 124 and 230 are used in an analogous manner at the cable system headend 222. Set top box 136 operates as previously described, but set top box 236 uses DRM systems C 240. In this manner, the system of FIG. 3 is able to utilize DRM systems from multiple manufacturers. As described previously, conditional access can be layered on top of the DRM systems B and C in a further embodiment.

Thus, method of encrypting a digital television signal consistent with certain embodiments involves examining unencrypted packets of data in the digital television signal to identify a packet type; duplicating packets identified as being of the packet type to create first and second duplicate packets; encrypting the first duplicate packets according to a first Digital Rights Management (DRM) encryption method to create first DRM encrypted packets; encrypting the second duplicate packets according to a second DRM encryption method to create second DRM encrypted packets; and replacing the unencrypted packets of the packet type with the first DRM encrypted packets and the second DRM encrypted packets in the digital television signal to produce a multiple partially encrypted digital television signal.

In accordance with certain embodiments consistent with the present invention, the digital television signal can come from either a cable or satellite system Headend or or Gateway set-top box. “Packets” can be MPEG transport packets, IEEE1394 packets, or IP packets. IP packets can be variable length with only “critical” data being placed in a packet.

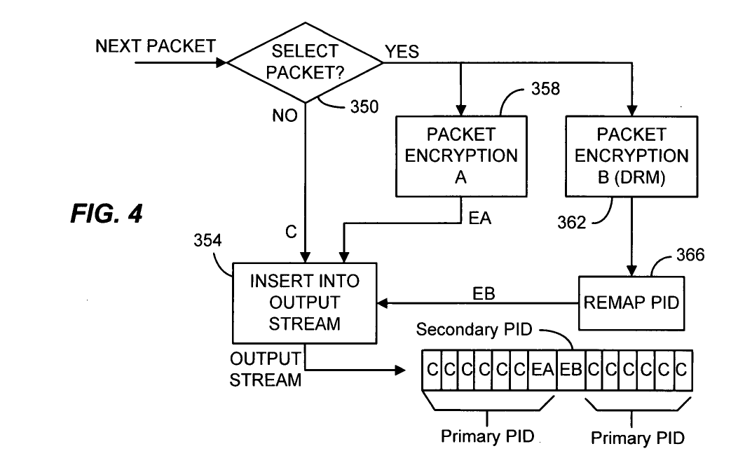

FIG. 4 is a flow chart depicting an exemplary encoding process such as that which would be used at headend 122 of FIG. 2 or headend 222 of FIG. 3. When a transport stream packet is received at 350, the packet is examined to determine if it meets a selection criteria for encryption. If not, the packet is passed as a clear unencrypted packet (C) for insertion into the output data stream at 354. If the packet meets the criteria, it is encrypted under CA encryption system A at 358 (or DRM system C at 240) to produce an encrypted packet EA. The packet is also duplicated and encrypted under DRM encryption system B at 362 to produce an encrypted packet. This encrypted packet is mapped to a secondary PID at 366 to produce an encrypted packet EB. Encrypted packets EA and EB are inserted into the output data stream along with clear packets C at 354. Preferably, the EA and EB packets are inserted at the location in the data stream where the single original packet was obtained for encryption so that the sequencing of the data remains essentially the same.

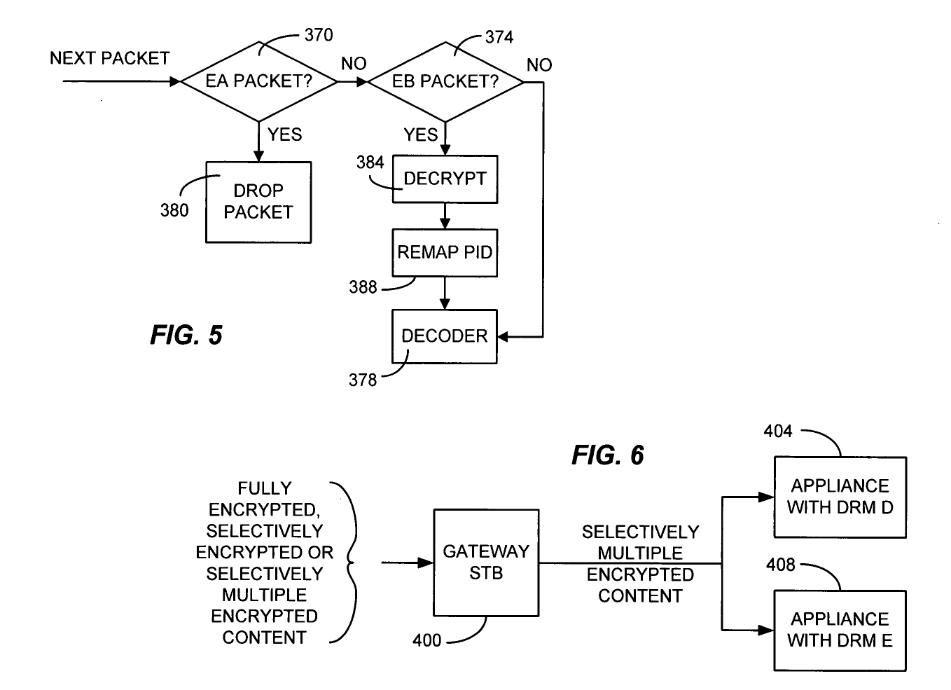

When the output data stream from 354 is received at an STB compliant with DRM system B such as 136 of FIG. 3, a process such as that of FIG. 5 can be utilized to decrypt and decode the program. When a packet is received having either the primary or the secondary PID at 370, a determination is made as to whether the packet is clear (C) or encrypted under CA system A (EA)(or DRM system C) at 370 or encrypted under DRM system B (EB) at 374. If the packet is clear, it is passed directly to the decoder 378. In some embodiments, the relative position of the primary packet, before or after, to the secondary packet may be used to signal a primary packet for replacement in the stream. A check of the scrambling state of the primary packet is not specifically required. If the packet is an EA packet, it is dropped at 380. If the packet is an EB packet, it is decrypted at 384. At this point, the secondary PID packets and/or the primary PID packets are remapped to the same PID at 388. The decrypted and clear packets are decoded at 378, subject to the usage rules defined by the DRM system.

Another embodiment consistent with the present invention is depicted in FIG. 6, wherein content may be received 100% encrypted or selectively encrypted from the service provider at a set top box serving as a gateway (a gateway STB 400. The encrypted content is then decrypted, and then multiple selectively DRM encrypted by the gateway set-top box 400 for various appliances forming a part of a home network. In this embodiment, two such devices are depicted for illustrative purposes, appliance 404 using DRM technology D and appliance 408 using DRM technology E. The devices in the home network can select from two or more DRM technologies. Content may be decoded real-time or stored multiply encrypted. Encoding issues aside, music content, for example, could be Apple DRM as well as Microsoft (MS) Media Player DRM encrypted. This content would be playable devices such as Apple IPODs (supporting Apple DRM) as well as portable devices supporting MS Media Player.

In other embodiments, the content may be both CA and DRM multiple encrypted. In such embodiments, the gateway STB 400 may pass both forms of encryption into the home network. Alternatively, it may select either only the DRM encryption or only the CA encryption (if there are no DRM enabled devices) along with the clear packets to send into the home network.

DRM encryption can take the home network into account by enabling appliances in the home to share content directly from the headend or service provider. Alternatively, the DRM encryption can be modified by the gateway set-top box in order to customize the content after purchase for its particular home network. Alternatively, the DRM encryption can be synthesized by the gateway set-top box on selected control digital outputs, e.g. Digital Transmission Copy Protection (DTCP) on IEEE1394 or Microsoft Media Player DRM.

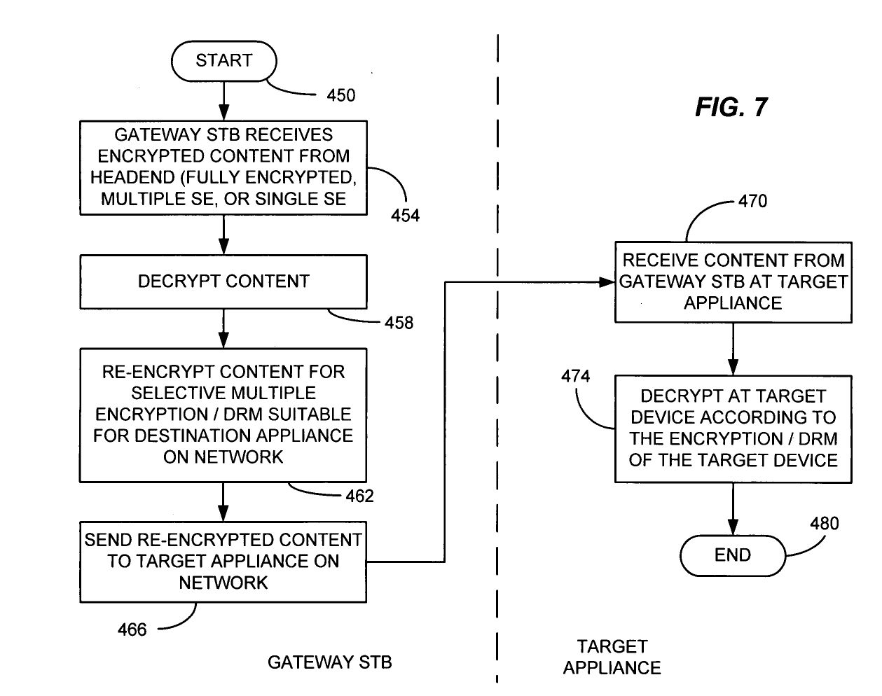

The Gateway STB 400 and associated appliances 404 and 408 of FIG. 6 can operate according to the process of FIG. 7, for example, starting at 450. At 454 the gateway STB receives encrypted content from the headend, which can be fully encrypted, multiple selectively encrypted or single selectively encrypted. The content is decrypted at 458 and then re-encrypted at 462 using a variation of selective selective multiple encryption/DRM suitable for the destination appliance (e.g. 404 or 408 of the network. The re-encrypted content is then sent to the target appliance over the network at 466. If the stream is multiple encrypted from the headend, then this makes it easier on the gateway STB since it does not need to generate extra copies of the packet.

The content from the gateway STB is received at the target appliance at 470. The re-encrypted content is then decrypted according to the encryption/DRM of the target appliance at 474. This process then ends at 480.

Thus, in a manner consistent with certain embodiments, a method of re-encrypting a digital television signal involves receiving an encrypted digital television signal at a gateway television set top box; decrypting the digital television signal; re-encrypting the digital television signal using a Digital Rights Management (DRM) system that is compatible with a first target appliance that is to receive the digital television signal; and sending the re-encrypted digital television signal to the first target appliance over a home network.

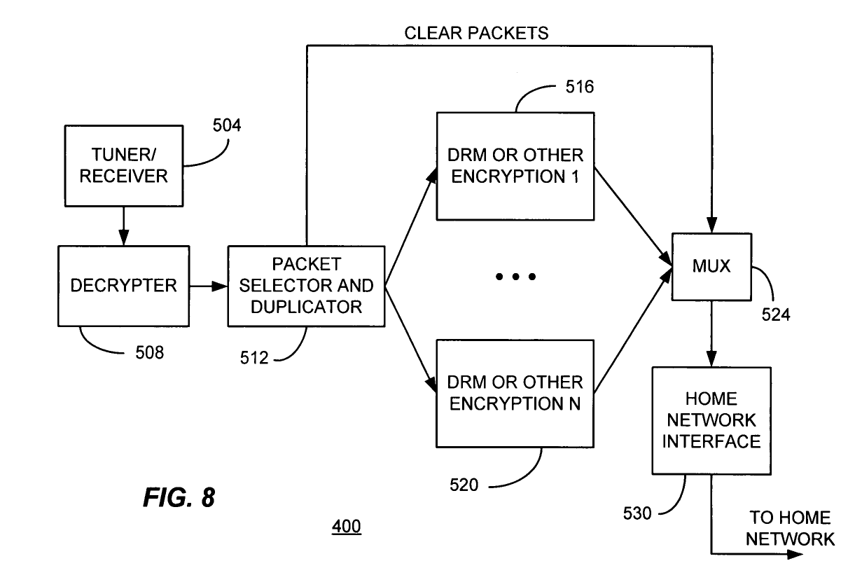

With reference to FIG. 8, an exemplary gateway STB such as 400 is depicted in functional block diagram form. In this embodiment, a tuner/receiver 504 receives content from the cable or satellite headend and supplies a digital data stream to decrypter 508. If the digital data stream is not selectively encrypted, the content undergoes a packet selection process at 512 that selects packets for ecryption according to a selection algorithm. If the packets are selectively encrypted, the encrypted packets can be assumed to be the appropriately selected packets according to a selection algorithm. The selected packets can then be duplicated at 512 so that duplicate packets are encrypted according to any one of the available encryption/DRM algorithms suitable to the target device at devices 516 through 520. The packets are then multiplexed with clear packets at 524 to produce a multiple selective encrypted stream of content using either CA encryption or DRM encryption as dictated by the target devices. The multiple selective encrypted stream of content is then routed to the target devices over the home network via home network interface 530.

Those skilled in the art will recognize, upon consideration of the above teachings, that certain of the above exemplary embodiments are based upon use of a programmed processor such as processor 130. However, the invention is not limited to such exemplary embodiments, since other embodiments could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments.

Those skilled in the art will appreciate, upon consideration of the above teachings, that the program operations and processes and associated data used to implement certain of the embodiments described above can be implemented using disc storage as well as other forms of storage such as for example Read Only Memory (ROM) devices, Random Access Memory (RAM) devices, network memory devices, optical storage elements, magnetic storage elements, magneto-optical storage elements, flash memory, core memory and/or other equivalent volatile and non-volatile storage technologies without departing from certain embodiments of the present invention. Such alternative storage devices should be considered equivalents.

Certain embodiments described herein, are or may be implemented using a programmed processor executing programming instructions that are broadly described above in flow chart form that can be stored on any suitable electronic or computer readable storage medium and/or can be transmitted over any suitable electronic communication medium. However, those skilled in the art will appreciate, upon consideration of the present teaching, that the processes described above can be implemented in any number of variations and in many suitable programming languages without departing from embodiments of the present invention. For example, the order of certain operations carried out can often be varied, additional operations can be added or operations can be deleted without departing from certain embodiments of the invention. Error trapping can be added and/or enhanced and variations can be made in user interface and information presentation without departing from certain embodiments of the present invention. Such variations are contemplated and considered equivalent.

While certain illustrative embodiments have been described, it is evident that many alternatives, modifications, permutations and variations will become apparent to those skilled in the art in light of the foregoing description.

1. A method of encrypting a digital television signal, comprising:
examining unencrypted packets of data in the digital television signal to identify a packet type;
duplicating packets identified as being of the packet type to create first and second duplicate packets;
encrypting the first duplicate packets according to a conditional access encryption method to create conditional access encrypted packets;
encrypting the second duplicate packets according to a Digital Rights Management (DRM) encryption method to create DRM encrypted packets; and
replacing the unencrypted packets of the packet type with the conditional access encrypted packets and the DRM encrypted packets in the digital television signal to produce a multiple partially encrypted digital television signal.

2. The method according to claim 1, further comprising distributing the multiple partially encrypted digital television signal along with DRM metadata that defines usage rights for the DRM encrypted packets.

3. The method according to claim 1, wherein the packet type comprises a packet carrying information that is needed to decode the digital television signal.

4. The method according to claim 3, wherein the packet carrying information that is needed to decode the digital television signal comprises a variable length Internet protocol packet.

5. The method according to claim 1, further comprising assigning a packet identifier to the unencrypted packets.

6. The method according to claim 4, wherein the packet identifier comprises a primary packet identifier; and further comprising assigning the primary packet identifier to the conditional access encrypted packets and assigning a secondary packet identifier to the DRM encrypted packets.

7. The method according to claim 4, wherein the packet identifier comprises a primary packet identifier; and further comprising assigning the primary packet identifier to the DRM encrypted packets and assigning a secondary packet identifier to the conditional access encrypted packets.

8. The method according to claim 1, carried out in either a cable television system headend or a gateway television set top box.

9. The method according to claim 1, wherein the packets comprise one of MPEG compliant packets, IEEE1394 compliant packets, or Internet Protocol packets.

10. An electronic storage medium storing instructions which, when executed on a programmed processor, carry out the method of encrypting a television signal according to claim 1.

11. An electronic transmission medium carrying an encrypted television signal encrypted by the method according to claim 1.

12. A method of encrypting a digital television signal, comprising:
examining unencrypted packets of data in the digital television signal to identify a packet type;
duplicating packets identified as being of the packet type to create first and second duplicate packets;
encrypting the first duplicate packets according to a first Digital Rights Management (DRM) encryption method to create first DRM encrypted packets;
encrypting the second duplicate packets according to a second DRM encryption method to create second DRM encrypted packets; and
replacing the unencrypted packets of the packet type with the first DRM encrypted packets and the second DRM encrypted packets in the digital television signal to produce a multiple partially encrypted digital television signal.

13. The method according to claim 12, further comprising distributing the multiple partially encrypted digital television signal along with first and second DRM metadata that defines usage rights for the first and second DRM encrypted packets respectively.

14. The method according to claim 12, wherein the packet type comprises a packet carrying information that is needed to decode the digital television signal.

15. The method according to claim 14, wherein the packet carrying information that is needed to decode the digital television signal comprises a variable length Internet protocol packet.

16. The method according to claim 12, further comprising assigning a packet identifier to the unencrypted packets.

17. The method according to claim 16, wherein the packet identifier comprises a primary packet identifier; and further comprising assigning the primary packet identifier to the first DRM encrypted packets and assigning a secondary packet identifier to the second DRM encrypted packets.

18. The method according to claim 12, carried out in either a cable television system headend or a gateway television set top box.

19. The method according to claim 12, wherein the packets comprise one of MPEG compliant packets, IEEE1394 compliant packets, or Internet Protocol packets.

20. An electronic storage medium storing instructions which, when executed on a programmed processor, carry out the method of encrypting a television signal according to claim 12.

21. An electronic transmission medium carrying an encrypted television signal encrypted by the method according to claim 12.

22. An encrypted television program, comprising:
a plurality of unencrypted packets; and
a plurality of encrypted packets, wherein the encrypted packets comprise at least a first encrypted packet encrypted under first Digital Rights Management (DRM) encryption method and a second encrypted packet encrypted under a second encryption method.

23. The encrypted television program according to claim 22, wherein the second encrypted packet is encrypted under a second DRM encryption method and wherein the second DRM encrypted packet has digital rights that are different than those of the first DRM encrypted packet.

24. The encrypted television program according to claim 22, wherein the second encrypted packet is encrypted under a conditional access encryption method.

25. The encrypted television program according to claim 22, wherein the digital television program is encoded according to an MPEG standard, and wherein the first encrypted packet of each of the plurality of encrypted packets and the unencrypted packets are identified by a primary packet identifier and the second encrypted packet of each of the plurality of encrypted packets are identified by a secondary packet identifier.

26. The encrypted television program according to claim 22, wherein the digital television program is encoded according to an MPEG standard, and wherein the second encrypted packet of each of the plurality of encrypted packets and the unencrypted packets are identified by a primary packet identifier, and wherein the first encrypted packet of each of the plurality of encrypted packets are identified by a secondary packet identifier.

27. The method according to claim 22, wherein the packets comprise one of MPEG compliant packets, IEEE1394 compliant packets, or Internet Protocol packets.

28. A television set-top box, comprising:
a receiver receiving a digital television signal comprising:
a plurality of unencrypted packets; and
a plurality of encrypted packets, wherein the encrypted packets comprise at least a first encrypted packet encrypted under first Digital Rights Management (DRM) encryption method and a second encrypted packet encrypted under a second encryption method;
a decrypter that decrypts either packets encrypted under the first or the second encryption method to produce decrypted packets; and
a decoder that decodes the unencrypted packets and the decrypted packets to produce a signal suitable for play on a television set.

29. The apparatus according to claim 28, wherein the second encrypted packets comprise second Digital Rights Management encrypted packets, and wherein the second DRM encrypted packets have digital rights that are different than those of the first DRM encrypted packets.

30. The apparatus according to claim 28, wherein the digital television signal complies with an MPEG standard, and wherein the first encrypted packet of each of the plurality of encrypted packets and the unencrypted packets are identified by a primary packet identifier and the second encrypted packet of each of the plurality of encrypted packets are identified by a secondary packet identifier.

31. The apparatus according to claim 28, wherein the digital television signal complies with an MPEG standard, and wherein the second encrypted packet of each of the plurality of encrypted packets and the unencrypted packets are identified by a primary packet identifier, and wherein the first encrypted packet of each of the plurality of encrypted packets are identified by a secondary packet identifier.

32. A method of decrypting a multiple partially encrypted television signal, comprising:
receiving a digital television signal comprising a plurality of packets, wherein certain packets of the plurality of packets are encrypted packets, wherein the encrypted packets comprise at least a first encrypted packet encrypted under first encryption method and a second encrypted packet encrypted under a second encryption method, and a remainder of the packets are unencrypted, wherein the first encrypted packets are encrypted under a Digital Rights Management encryption method; and
decrypting a packet encrypted under one of the first and second encryption methods to produce decrypted packets.

33. The method according to claim 32, further comprising decoding the decrypted packets and the unencrypted packets to produce a decoded television signal.

34. The method according to claim 32, wherein the receiving, decrypting and decoding are carried out in a television device.

35. The method according to claim 32, wherein the television device comprises a television set-top box.

36. An electronic storage medium storing instructions which, when executed on a programmed processor, carry out the method of decoding according to claim 32.

37. A method of decrypting a partially encrypted television signal, comprising:
receiving the partially encrypted television signal comprising a plurality of clear packets, a plurality of packets encrypted under a first encryption algorithm, and a plurality of packets encrypted under a second encryption algorithm;
wherein the packets encrypted under the first encryption algorithm is encrypted under a Digital Rights Management method;
wherein the packets encrypted under the first and second encryption algorithms are packets that are needed to properly decode the television signal;
wherein the clear packets are identified by a first packet identifier;
wherein the packets encrypted under the first encryption algorithm are identified by a second packet identifier (PID), and wherein the packets encrypted under the second encryption algorithm are identified by a third packet identifier (PID); and
decrypting the packets encrypted under the first encryption algorithm to produce decrypted packets.

38. The method according to claim 37, further comprising decoding the decrypted packets and the clear packets.

39. The method according to claim 37, wherein the packets encrypted under the first encryption method have associated rights that are determined by DRM metadata that forms a part of the partially encrypted television program.

40. The method according to claim 37, wherein the packets encrypted under the second encryption method comprise second DRM encrypted packets, and wherein the second DRM encrypted packets have associated rights that differ from the those of the first DRM encrypted packets.

41. The method according to claim 37, wherein the packets comprise one of MPEG compliant packets, IEEE1394 compliant packets, or Internet Protocol packets.

42. An electronic storage medium storing instructions which, when executed on a programmed processor, carry out the method of decrypting a television signal according to claim 37.

43. A computer data signal embodied in a bit stream, comprising:
a segment of data representing an unencrypted packet;
a segment of data representing a first duplicate packet encrypted under a first encryption method, wherein the first encryption method comprises a Digital Rights Management (DRM) encryption method; and
a segment of data representing a second duplicate packet encrypted under a second encryption method.

44. The computer data signal according to claim 43, wherein the segment of data representing an unencrypted packet, the segment of data representing a first duplicate packet encrypted under a first encryption method, and the segment of data representing a second duplicate packet encrypted under a second encryption method all represent the same data.

45. The computer data signal according to claim 43, further comprising metadata defining rights associated with the data segment encrypted under the DRM encryption method.

46. The computer data signal according to claim 43, wherein the second encryption method comprises a second DRM encryption method.

47. The computer data signal according to claim 43, further comprising metadata defining rights associated with the data segment encrypted under the second DRM encryption method.

48. The method according to claim 43, wherein the packets comprise one of MPEG compliant packets, IEEE1394 compliant packets, or Internet Protocol packets.

49. A method of re-encrypting a digital television signal, comprising:
receiving an encrypted digital television signal at a gateway television set top box;
decrypting the digital television signal;
re-encrypting the digital television signal using a Digital Rights Management (DRM) system that is compatible with a first target appliance that is to receive the digital television signal; and
sending the re-encrypted digital television signal to the first target appliance over a home network.

50. The method according to claim 49, further comprising:
duplicating selected packets in the digital television signal to create first and second duplicate packets;
re-encrypting the duplicate packets according to a conditional access encryption method to create conditional access encrypted packets suitable for a second target applicance; and
replacing decrypted selected packets with the conditional access encrypted packets and the DRM encrypted packets in the digital television signal to produce a multiple selectively encrypted digital television signal;
wherein the sending includes sending the multiple selectively encrypted digital television signal is sent is sent by the home network to the first and second target appliances.

51. The method according to claim 49, further comprising sending the re-encrypted the digital television signal along with DRM metadata that defines usage rights for the DRM encrypted packets.

52. The method according to claim 49, wherein the packets comprise one of MPEG compliant packets, IEEE1394 compliant packets, or Internet Protocol packets.

53. An electronic storage medium storing instructions which, when executed on a programmed processor, carry out the method of encrypting a television signal according to claim 49.

54. An electronic transmission medium carrying an encrypted television signal that is re-encrypted by the method according to claim 49.

55. A gateway television set top box, comprising:
means for receiving an encrypted digital television signal;
a decrypter that decrypts the encrypted digital television signal to produce a decrypted digital television signal;
a first encrypter that re-encrypts the decrypted digital television signal in a manner compliant with a Digital Rights Management that is compatible with a first target appliance; and
a network interface that receives the re-encrypted digital television signal and sends the re-encrypted digital television signal to the target appliance.

56. The gateway television set top box according to claim 55, further comprising:
a second encrypter that re-encrypts the decrypted digital television signal in a manner that is compatible with a second target appliance;
a multiplexer that combines the re-encrypted digital television signals from the first and second encrypters to produce a multiple selectively encrypted television signal; and
wherein the network interface receives the multiple selectively encrypted digital television signal and sends the multiple selectively encrypted digital television signal to the first and second target appliances.

57. The gateway television set top box according to claim 55, wherein the network interface sends the re-encrypted the digital television signal along with DRM metadata that defines usage rights for the DRM encrypted packets.

58. The gateway television set top box according to claim 55, wherein the multiple selectively encrypted digital television signal is packetized, and wherein the packets comprise one of MPEG compliant packets, IEEE1394 compliant packets, or Internet Protocol packets.

59. The gateway television set top box according to claim 55, further comprising a packet selector that selects packets for re-encryption according to a selective encryption selection algorithm.

60. The gateway television set top box according to claim 56, further comprising a packet selector that selects packets for re-encryption according to a selective encryption selection algorithm.

61. The gateway television set top box according to claim 60, further comprising a packet duplicator that duplicates selected packets for re-encryption under a plurality of encryption systems to produce the selective multiple encrypted television signal.
